(19) United States
(12) Patent Application Publication
(10) Pub. No.: US 2022/0014877 A1
(43) Pub. Date: Jan. 13, 2022

(54) USING MIRRORS AS A POSITIONING SOLUTION

(71) Applicant: Telefonaktiebolaget LM Ericsson (publ), Stockholm (SE)

(72) Inventors: Erik STARE, Sollentuna (SE); Iana SIOMINA, TÄBY (SE); Sara Modarres RAZAVI, LINKÖPING (SE); Fredrik GUNNARSSON, LINKÖPING (SE); Andreas BERGSTRÖM, LINKÖPING (SE); Ritesh SHREEVASTAV, UPPLANDS VÄSBY (SE); Per ERNSTRÖM, Stockholm (SE)

(21) Appl. No.: 17/291,868

(22) PCT Filed: Oct. 28, 2019
(86) PCT No.: PCT/SE2019/051071

§ 371 Date: May 6, 2021

Related U.S. Application Data
(60) Provisional application No. 62/757,933, filed on Nov. 9, 2018.

(51) Int. Cl. H04W 4/029; G01S 5/02

(52) U.S. Cl. CPC H04W 4/029; G01S 5/0236; G01S 5/02524

(57) ABSTRACT

Methods and apparatuses are disclosed for using mirrors for positioning. In one embodiment, a method implemented in a wireless device includes receiving an indication of at least one mirror from a network node, the at least one mirror being used for positioning the wireless device; performing a measurement on at least one reference signal reflected by the indicated at least one mirror; and performing at least one operational task associated with positioning the wireless device based at least in part on the measurement. In one embodiment, a method implemented in a network node includes indicating at least one mirror to a wireless device the at least one mirror being used for positioning the wireless device; and communicating at least one reference signal to the WD, the at least one reference signal to be reflected by the indicated at least one mirror for positioning the wireless device.

### TECHNICAL FIELD

Wireless communication and in particular, to using mirrors as a positioning solution.

### BACKGROUND

Positioning, i.e., location determination, is a feature in many industrial and commercial applications (for example intelligent transportation, entertainment, industry automation, robotics, remote operation, healthcare, smart parking and so on). Positioning is also relevant to United States (US) Federal Communications Commission (FCC) E911 requirements.

There are several different technologies which can be used for positioning purposes for such applications, and the usage of each technology can depend on several different characteristics of certain use-cases. A non-exhaustive list of characteristic parameters is listed as follows:
The price of the positioning solution;
The accuracy of the positioning solution;
The deployment complexity;
The receiver complexity;
The coverage perspective;
The need to have a standard network solution;
The latency aspect of the positioning solution; and
The energy efficiency of the positioning solution, etc.

Positioning in 3^{rd} Generation Partnership Project (3GPP) Long Term Evolution (LTE) networks can be supported by interactions between a wireless device (WD), e.g., user equipment (UE), and a location server (e.g., Enhanced-Serving Mobile Location Center (E-SMLC)) via, e.g., the LTE Positioning Protocol (LPP). Moreover, there may also be interactions between the location server and the network node (e.g., eNodeB) via the LPPa protocol, and to some extent supported by interactions between the network node and the WD via a Radio Resource Control (RRC) protocol.

The following positioning techniques may be considered in LTE:
Enhanced Cell identification (ID). Essentially, cell ID information to associate the WD to the serving area of a serving cell, and then additional information to determine a finer granularity position.
Assisted Global Navigation Satellite System (GNSS). GNSS information retrieved by the WD, supported by assistance information provided to the WD from E-SMLC.
Observed Time Difference of Arrival (OTDOA). The WD estimates the time difference of reference signals from different network nodes and sends such estimates to the E-SMLC for multilateration.
Uplink TDOA (UTDOA). The WD is requested to transmit a specific waveform that is detected by multiple location measurement units (e.g., an eNB) at known positions. These measurements may then be forwarded to the E-SMLC for multilateration.

There are certain use-cases in which it may be preferred to have a similar deployment, which provides communication coverage to also fix the positioning estimation. This may be true for all standard LTE positioning techniques in which the network that provides the communication is also providing a positioning fix. However, in some use cases, existing positioning techniques may not provide sufficient positioning accuracy.

### SUMMARY

Some embodiments advantageously provide methods and apparatuses for using mirrors as a positioning solution.

In some embodiments, a method for a network node (or a WD in some embodiments) may include obtaining a mirror configuration; communicating at least one reference signal to be reflected by at least one mirror associated with the mirror configuration; and receiving a measurement report, the measurement report based at least in part on the reflected at least one reference signal.

In some embodiments, a method for a WD (or a network node in some embodiments) may include receiving an indication of an existence of at least one mirror associated with a network node; performing a measurement on at least one reference signal reflected by the at least one mirror; and performing at least one operational task based at least in part on the measurement performed on the reflected at least one reference signal.

According to one aspect of the present disclosure, a method implemented in a wireless device, WD, is provided. The method includes receiving an indication of at least one mirror from a network node, the at least one mirror being used for positioning the wireless device. The method includes performing a measurement on at least one reference signal reflected by the indicated at least one mirror. The method includes performing at least one operational task associated with positioning the wireless device based at least in part on the measurement.

In some embodiments of this aspect, the at least one mirror represents at least one virtual transmission point, vTP. In some embodiments of this aspect, receiving the indication of the at least one mirror from the network node further includes receiving an existence of the at least one mirror associated with the network node. In some embodiments of this aspect, receiving the indication of the at least one mirror from the network node further includes at least one mirror configuration of the at least one mirror. In some embodiments of this aspect, receiving the indication of the at least one mirror from the network node further includes a reference signal configuration associated with the at least one mirror. In some embodiments of this aspect, receiving the indication of the at least one mirror from the network node further includes assistance data including the at least one mirror configuration of the at least one mirror.

In some embodiments of this aspect, the at least one mirror configuration includes a reflection direction associated with the at least one mirror. In some embodiments of this aspect, the at least one mirror configuration includes a transmission point location corresponding to the at least one mirror. In some embodiments of this aspect, the at least one mirror configuration includes an indication of the at least one reference signal to be reflected by the at least one mirror. In some embodiments of this aspect, the at least one mirror configuration includes an indication of a set of time resources associated with the at least one mirror configuration. In some embodiments of this aspect, the at least one mirror configuration includes a cell identifier associating the at least one mirror configuration to a cell. In some embodiments of this aspect, the at least one mirror configuration includes a number of the at least one mirror. In some embodiments of this aspect, the at least one mirror configuration includes a location of each of the at least one mirror. In some embodiments of this aspect, the at least one mirror configuration includes a request for a measurement associated with the at least one mirror configuration.

In some embodiments of this aspect, performing the at least one operational task based at least in part on the measurement further includes estimating a position of the WD based at least in part on the measurement. In some embodiments of this aspect, performing the at least one operational task based at least in part on the measurement further includes communicating a measurement report, the measurement report based at least in part on the measurement. In some embodiments of this aspect, performing the at least one operational task based at least in part on the measurement further includes updating a radio measurement map based at least in part on the measurement. In some embodiments of this aspect, the measurement report is a multipath report reporting on a number of paths, the number of paths based at least in part on a number of the at least one mirror associated with the network node. In some embodiments of this aspect, the method further includes receiving the at least one reference signal according to the indication of the at least one mirror.

According to another aspect of the present disclosure, a wireless device, WD, configured to communicate with a network node is provided. The WD includes processing circuitry. The processing circuitry is configured to cause the WD to receive an indication of at least one mirror from a network node, the at least one mirror being used for positioning the wireless device. The processing circuitry is configured to cause the WD to perform a measurement on at least one reference signal reflected by the indicated at least one mirror. The processing circuitry is configured to cause the WD to perform at least one operational task associated with positioning the wireless device based at least in part on the measurement.

In some embodiments of this aspect, the at least one mirror represents at least one virtual transmission point, vTP. In some embodiments of this aspect, the processing circuitry is further configured to cause the wireless device to receive the indication of the at least one mirror from the network node by being configured to cause the wireless device to receive an existence of the at least one mirror associated with the network node. In some embodiments of this aspect, the processing circuitry is further configured to cause the wireless device to receive the indication of the at least one mirror from the network node by being configured to cause the wireless device to receive at least one mirror configuration of the at least one mirror. In some embodiments of this aspect, the processing circuitry is further configured to cause the wireless device to receive the indication of the at least one mirror from the network node by being configured to cause the wireless device to receive a reference signal configuration associated with the at least one mirror. In some embodiments of this aspect, the processing circuitry is further configured to cause the wireless device to receive the indication of the at least one mirror from the network node by being configured to cause the wireless device to receive assistance data including the at least one mirror configuration of the at least one mirror.

In some embodiments of this aspect, the at least one mirror configuration includes a reflection direction associated with the at least one mirror. In some embodiments of this aspect, the at least one mirror configuration includes a transmission point location corresponding to the at least one mirror. In some embodiments of this aspect, the at least one mirror configuration includes an indication of the at least one reference signal to be reflected by the at least one mirror. In some embodiments of this aspect, the at least one mirror configuration includes an indication of a set of time resources associated with the at least one mirror configuration. In some embodiments of this aspect, the at least one mirror configuration includes a cell identifier associating the at least one mirror configuration to a cell. In some embodiments of this aspect, the at least one mirror configuration includes a number of the at least one mirror. In some embodiments of this aspect, the at least one mirror configuration includes a location of each of the at least one mirror. In some embodiments of this aspect, the at least one mirror configuration includes a request for a measurement associated with the at least one mirror configuration.

In some embodiments of this aspect, the processing circuitry is further configured to cause the wireless device to perform the at least one operational task based at least in part on the measurement by being configured to cause the wireless device to estimate a position of the WD based at least in part on the measurement. In some embodiments of this aspect, the processing circuitry is further configured to cause the wireless device to perform the at least one operational task based at least in part on the measurement by being configured to cause the wireless device to communicate a measurement report, the measurement report based at least in part on the measurement. In some embodiments of this aspect, the processing circuitry is further configured to cause the wireless device to perform the at least one operational task based at least in part on the measurement by being configured to cause the wireless device to update a radio measurement map based at least in part on the measurement.

In some embodiments of this aspect, the measurement report is a multipath report reporting on a number of paths, the number of paths based at least in part on a number of the at least one mirror associated with the network node. In some embodiments of this aspect, the processing circuitry is further configured to cause the wireless device to receive the at least one reference signal according to the indication of the at least one mirror.

According to yet another aspect of the present disclosure, a method implemented in a network node is provided. The method includes indicating at least one mirror to a wireless device, WD, the at least one mirror being used for positioning the wireless device. The method includes communicating at least one reference signal to the WD, the at least one reference signal to be reflected by the indicated at least one mirror for positioning the wireless device. The method includes optionally, receiving a measurement report, the measurement report based at least in part on the reflected at least one reference signal.

In some embodiments of this aspect, the indicated at least one mirror represents at least one virtual transmission point, vTP. In some embodiments of this aspect, indicating the at least one mirror to the WD further includes indicating an existence of the at least one mirror associated with the network node. In some embodiments of this aspect, indicating the at least one mirror to the WD further includes indicating at least one mirror configuration of the at least one mirror. In some embodiments of this aspect, indicating the at least one mirror to the WD further includes indicating a reference signal configuration associated with the at least one mirror. In some embodiments of this aspect, indicating the at least one mirror to the WD further includes indicating assistance data including the at least one mirror configuration of the at least one mirror.

In some embodiments of this aspect, the at least one mirror configuration includes a reflection direction associated with the at least one mirror. In some embodiments of this aspect, the at least one mirror configuration includes a transmission point location corresponding to the at least one mirror. In some embodiments of this aspect, the at least one mirror configuration includes an indication of the at least one reference signal to be reflected by the at least one mirror. In some embodiments of this aspect, the at least one mirror configuration includes an indication of a set of time resources associated with the at least one mirror configuration. In some embodiments of this aspect, the at least one mirror configuration includes a cell identifier associating the at least one mirror configuration to a cell. In some embodiments of this aspect, the at least one mirror configuration includes a number of the at least one mirror. In some embodiments of this aspect, the at least one mirror configuration includes a location of each of the at least one mirror. In some embodiments of this aspect, the at least one mirror configuration includes a request for a measurement associated with the at least one mirror configuration.

In some embodiments of this aspect, the method further includes performing at least one operational task based at least in part on the received measurement report. In some embodiments of this aspect, the measurement report is a multipath report reporting on a number of paths, the number of paths based at least in part on a number of the at least one mirror. In some embodiments of this aspect, the method further includes estimating a position of the WD based at least in part on the received measurement report.

According to another aspect of the present disclosure, a network node configured to communicate with a wireless device, WD, is provided. The network node includes processing circuitry. The processing circuitry is configured to cause the network node to indicate at least one mirror to a wireless device, WD, the at least one mirror being used for positioning the wireless device. The processing circuitry is configured to cause the network node to communicate at least one reference signal to the WD, the at least one reference signal to be reflected by the indicated at least one mirror for positioning the wireless device. The processing circuitry is configured to cause the network node to optionally, receive a measurement report, the measurement report based at least in part on the reflected at least one reference signal.

In some embodiments of this aspect, the indicated at least one mirror represents at least one virtual transmission point, vTP. In some embodiments of this aspect, the processing circuitry is further configured to cause the network node to indicate the at least one mirror to the WD by being further configured to cause the network node to indicate an existence of the at least one mirror associated with the network node. In some embodiments of this aspect, the processing circuitry is further configured to cause the network node to indicate the at least one mirror to the WD by being further configured to cause the network node to indicate at least one mirror configuration of the at least one mirror. In some embodiments of this aspect, the processing circuitry is further configured to cause the network node to indicate the at least one mirror to the WD by being further configured to cause the network node to indicate a reference signal configuration associated with the at least one mirror. In some embodiments of this aspect, the processing circuitry is further configured to cause the network node to indicate the at least one mirror to the WD by being further configured to cause the network node to indicate assistance data including the at least one mirror configuration of the at least one mirror.

In some embodiments of this aspect, the at least one mirror configuration includes a reflection direction associated with the at least one mirror. In some embodiments of this aspect, the at least one mirror configuration includes a transmission point location corresponding to the at least one mirror. In some embodiments of this aspect, the at least one mirror configuration includes an indication of the at least one reference signal to be reflected by the at least one mirror. In some embodiments of this aspect, the at least one mirror configuration includes an indication of a set of time resources associated with the at least one mirror configuration. In some embodiments of this aspect, the at least one mirror configuration includes a cell identifier associating the at least one mirror configuration to a cell. In some embodiments of this aspect, the at least one mirror configuration includes a number of the at least one mirror. In some embodiments of this aspect, the at least one mirror configuration includes a location of each of the at least one mirror. In some embodiments of this aspect, the at least one mirror configuration includes a request for a measurement associated with the at least one mirror configuration.

In some embodiments of this aspect, the processing circuitry is further configured to cause the network node to perform at least one operational task based at least in part on the received measurement report. In some embodiments of this aspect, the measurement report is a multipath report reporting on a number of paths, the number of paths based at least in part on a number of the at least one mirror. In some embodiments of this aspect, the processing circuitry is further configured to cause the network node to estimate a position of the WD based at least in part on the received measurement report.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node for mirror configuration unit according to some embodiments of the present disclosure;

FIG. 8 is a flowchart of an exemplary process in a wireless device for measurement unit according to some embodiments of the present disclosure;

FIG. 9 illustrates an example embodiment of this disclosure from the network node perspective;

FIG. 10 illustrates yet another example embodiment of this disclosure from the network node perspective;

FIG. 11 illustrates an example embodiment of this disclosure from the WD perspective;

FIG. 12 illustrates yet another example embodiment of this disclosure from the WD perspective; and

FIG. 13 illustrates an example position of virtual transmission points utilizing a flat mirror reflecting radio waves according to some embodiments of this disclosure.

### DETAILED DESCRIPTION

For some scenarios such as factory automation, it may be possible to provide communication services using one or two cellular nodes. However, this number of nodes may not be sufficient for the positioning demands that a particular use-case has (e.g., in the range of a decimeter, centimeter, etc., level). Yet, adding more cellular nodes only for the purpose of positioning may be costly.

In some use-cases such as, for example, a dense city with street canyons, there may be strong multipath issues and hence positioning techniques may suffer in terms of providing a decent positioning estimation. Furthermore, ensuring signals from a sufficient number of distinct locations for such methods as OTDOA may be challenging due to low signal reachability in non-line-of-sight (non-LOS) conditions in some locations.

Accordingly, some embodiments of this disclosure provide for using mirrors, which can be relatively inexpensive hardware devices that can receive the signal directed towards it and can reflect the signal to another node (e.g., another mirror, a gNB) or to the WD. Mirrors could make it possible to virtually increase the number of network nodes, or to compensate for a low number of cellular nodes at a relatively low cost. This can benefit, e.g., positioning, e.g., TDOA methods that require measuring strong enough signals from multiple distinct locations, or pattern matching, or fingerprinting, which benefits from any additional fingerprints.

In some embodiments, non-limiting examples of advantages of the proposed solution(s) in this disclosure may include one or more of the following:
1—Improving the positioning estimation by the addition of mirrors as virtual transmission points (TPs).
2—Having a low-cost positioning solution for use-cases such as positioning in factory automation.
3—Using mirrors as a lower cost substitute as compared to relays.
4—Mirrors are low cost and easy to install.
5—In case of higher frequencies and beamforming, narrower beams may allow the size of the mirror to be reduced, and also provide more precise reflections of the signal for positioning purposes.
6—Increasing signal reachability in difficult radio environments such as canyons, tunnels, etc.

Before describing in detail exemplary embodiments, it is noted that the embodiments reside primarily in combinations of apparatus components and processing steps related to using mirrors as a positioning solution. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

In some embodiments, the term “mirror” may be used to indicate a reflective surface configured for use in a network to fully, substantially or at least partially (in some semi-transparent embodiments) reflect, redirect, deflect, reorient, etc., a signal, such as, a radio signal from a node, such as a network node or a WD, and particularly, in some embodiments, reference signals that may be used for positioning purposes.

A “reference signal” as used herein may be any kind of reference signal. In some embodiments, the signal to be reflected may include other types of non-reference signals. It should be understood that, although this disclosure describes use of mirrors as a positioning solution, the techniques disclosed herein may also be used to provide other types of network solutions, where, e.g., it may be advantageous to use redirect certain signals via reflective properties to, e.g., reduce a number of network nodes required to implement the solution.

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver.

Any two or more embodiments described in this disclosure may be combined in any way with each other.

The term “resource”, as used herein, is intended to be interpreted in a general way. It may indicate an arbitrary combination of subcarriers, time slots, codes and spatial dimensions.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “radio measurement” and “measurement” used herein may refer to any measurement performed on radio signals. Radio measurements can be absolute or relative. Radio measurement may be called as signal level which may be signal quality and/or signal strength. Radio measurements can be e.g. intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc.

In some embodiments, information on one or more resources may be considered to be transmitted in a message having a specific format. A message may comprise or represent bits representing payload information and coding bits, e.g., for error coding.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling (e.g., mirror configuration and/or reference signal configuration), may comprise a plurality of signals and/or messages, which may be transmitted on different carriers and/or be associated to different signaling processes, e.g. representing and/or pertaining to one or more such processes and/or corresponding information. An indication (e.g., indication of a signal to be reflected, an indication of a mirror configuration or an indication of an existence of a mirror associated with a mirror configuration, etc.) may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

Configuring a radio node, in particular a terminal or WD, may refer to the radio node being adapted or caused or set and/or instructed to operate according to the configuration (e.g., perform measurements on received reference signals according to the configuration, determine positioning based on the configuration, etc.). Configuring may be done by another device, e.g., a network node (for example, a base station or gNB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources. A radio node may configure itself, e.g., based on configuration data received from a network or network node. A network node may utilize, and/or be adapted to utilize, its circuitry/ies for configuring. Allocation information may be considered a form of configuration data. Configuration data may comprise and/or be represented by configuration information, and/or one or more corresponding indications and/or message/s.

A channel may generally be a logical or physical channel. A channel may comprise and/or be arranged on one or more carriers, in particular a plurality of subcarriers. A wireless communication network may comprise at least one network node, in particular a network node as described herein. A terminal connected or communicating with a network may be considered to be connected or communicating with at least one network node, in particular any one of the network nodes described herein.

A channel may generally be a logical, transport or physical channel. A channel may comprise and/or be arranged on one or more carriers, in particular a plurality of subcarriers. A channel carrying and/or for carrying control or configuration information signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have two component channels, one for each direction.

An indication (e.g., indication of a signal to be reflected, an indication of a mirror configuration or an indication of an existence of a mirror associated with a mirror configuration, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns or sequences representing the information.

A cell may be generally a communication cell, e.g., of a cellular or mobile communication network, provided by a node. A serving cell may be a cell on or via which a network node (the node providing or associated to the cell, e.g., base station or eNodeB) transmits and/or may transmit data (which may be data other than broadcast data) to a WD, in particular control and/or user or payload data, and/or via or on which a WD transmits and/or may transmit data to the node; a serving cell may be a cell for or on which the WD is configured and/or to which it is synchronized and/or has performed an access procedure, e.g., a random access procedure, and/or in relation to which it is in a RRC connected or RRC idle state, e.g., in case the node and/or WD and/or network follow the LTE-standard. One or more carriers (e.g., uplink and/or downlink carrier/s and/or a carrier for both uplink and downlink) may be associated to a cell.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

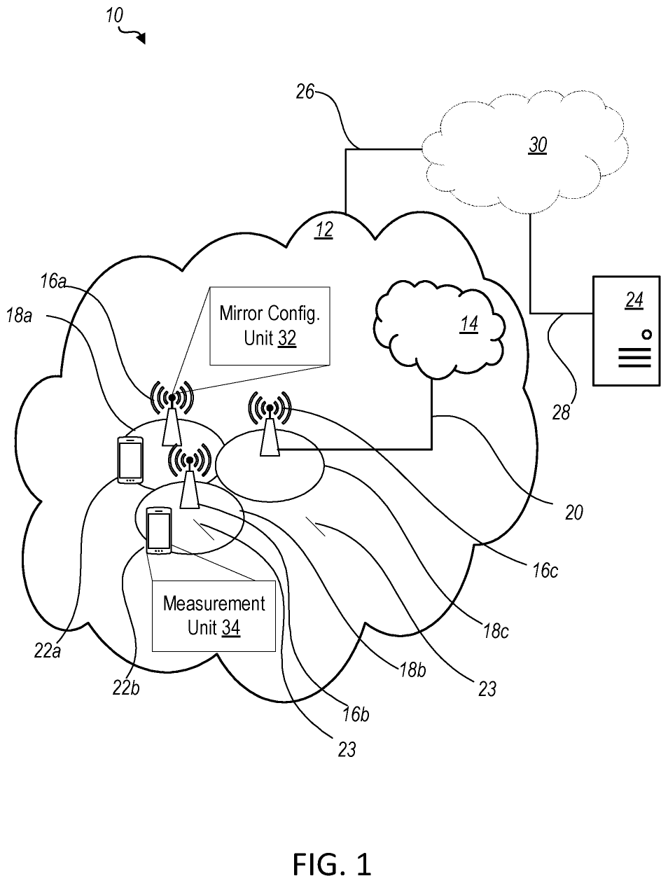

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Access network 12 may also contain one or more mirrors 23. Note that although only two WDs 22, two mirrors 23 and three network nodes 16 are shown for convenience, the communication system may include many more WDs 22, mirrors 23 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a mirror configuration unit 32 which is configured to indicate at least one mirror 23 to a wireless device 22, WD, the at least one mirror 23 being used for positioning the wireless device 22; communicate at least one reference signal to the WD 22, the at least one reference signal to be reflected by the indicated at least one mirror 23 for positioning the wireless device 22; and optionally, receive a measurement report, the measurement report based at least in part on the reflected at least one reference signal.

In another embodiment, the mirror configuration unit 32 is configured to determine a mirror configuration; communicate at least one reference signal to be reflected by at least one mirror 23 associated with the mirror configuration; and receive a measurement report, the measurement report based at least in part on the reflected at least one reference signal. In some embodiments, one or more of these functions may be performed by a WD 22 for an uplink (UL) reference signal communication by the WD 22.

A wireless device 22 is configured to include a measurement unit 34 which is configured to receive an indication of at least one mirror 23 from a network node 16, the at least one mirror 23 being used for positioning the wireless device 22; perform a measurement on at least one reference signal reflected by the indicated at least one mirror 23; and perform at least one operational task associated with positioning the wireless device 22 based at least in part on the measurement.

In another embodiment, the measurement unit 34 is configured to receive an indication of an existence of at least one mirror 23 associated with a network node 16; perform a measurement on at least one reference signal reflected by the at least one mirror 23; and perform at least one operational task based at least in part on the measurement performed on the reflected at least one reference signal. In some embodiments, one or more of these functions may be performed by a network node 16 for an uplink (UL) reference signal communication from the WD 22.

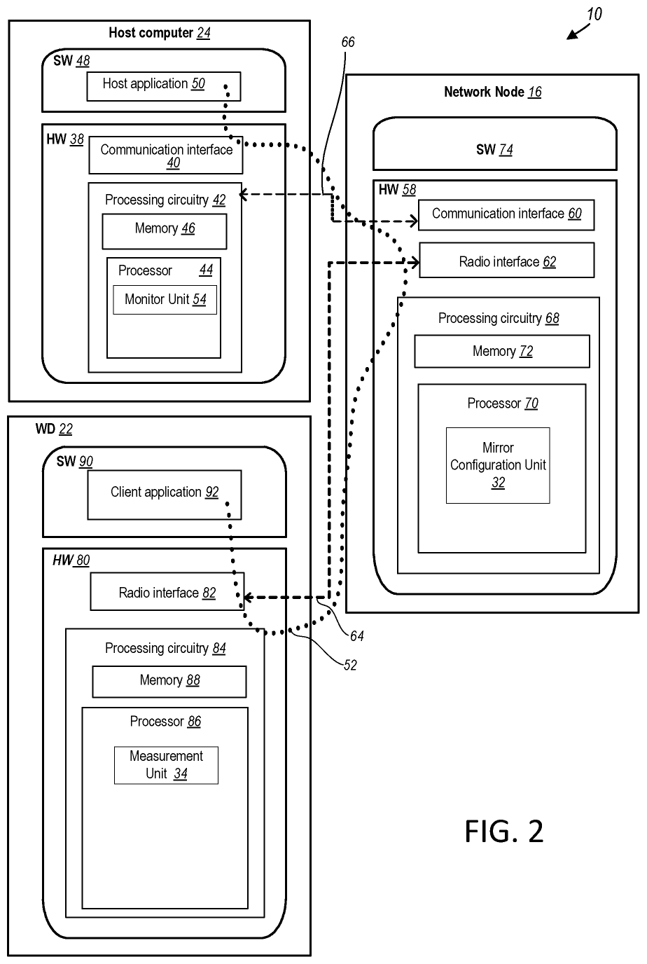

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

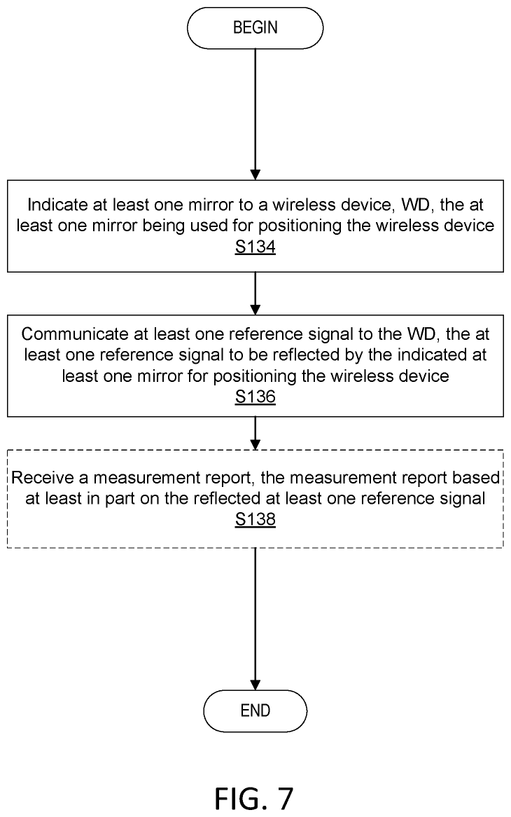

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16 such as the processes described with reference to FIG. 7. For example, processing circuitry 68 of the network node 16 may include mirror configuration unit 32 configured to determine a mirror configuration; communicate at least one reference signal to be reflected by at least one mirror 23 associated with the mirror configuration; and receive a measurement report, the measurement report based at least in part on the reflected at least one reference signal.

In some embodiments, the processing circuitry 68 is further configured to communicate an indication of the at least one reference signal to be reflected by the at least one mirror 23 associated with the mirror configuration. In some embodiments, the processing circuitry 68 is further configured to perform at least one operational task based at least in part on the measurement report. In some embodiments, the processing circuitry 68 is further configured to communicate at least one of an indication of the mirror configuration and an existence of the at least one mirror 23 associated with the mirror configuration to the WD 22.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

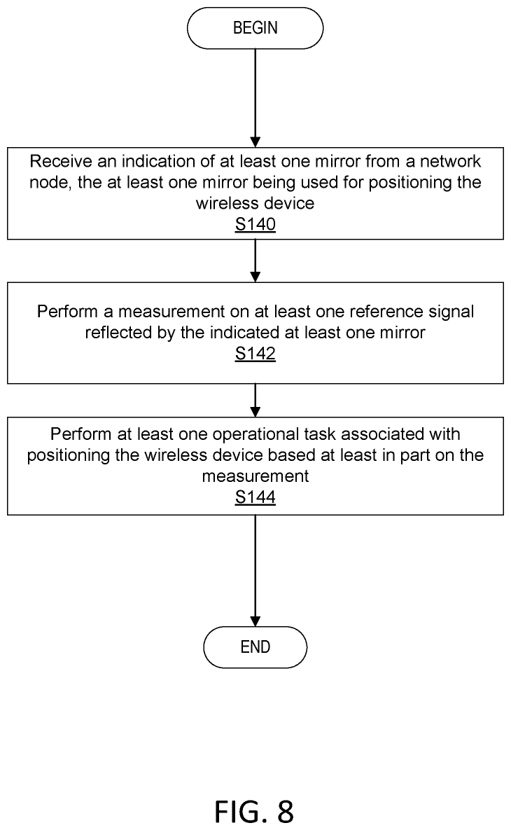

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22 such as the processes described with reference to FIG. 8. For example, the processing circuitry 84 of the wireless device 22 may include a measurement unit 34 configured to receive an indication of an existence of at least one mirror 23 associated with a network node 16; perform a measurement on at least one reference signal reflected by the at least one mirror 23; and perform at least one operational task based at least in part on the measurement performed on the reflected at least one reference signal.

In some embodiments, the processing circuitry 84 is further configured to receive the at least one reference signal reflected by the at least one mirror 23. In some embodiments, the processing circuitry 84 is further configured to communicate a measurement report, the measurement report based at least in part on the measurement performed on the at least one reference signal. In some embodiments, the measurement report is a multipath report with a number of paths in the multipath report based on a number of the at least one mirror 23 associated with the network node 16.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as mirror configuration unit 32, and measurement unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

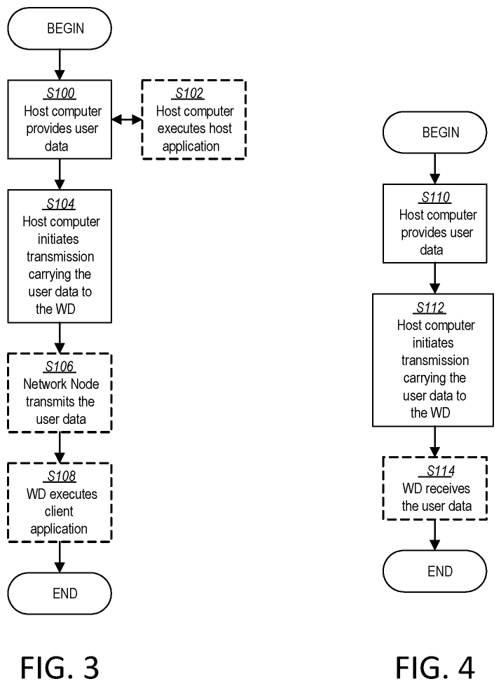

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

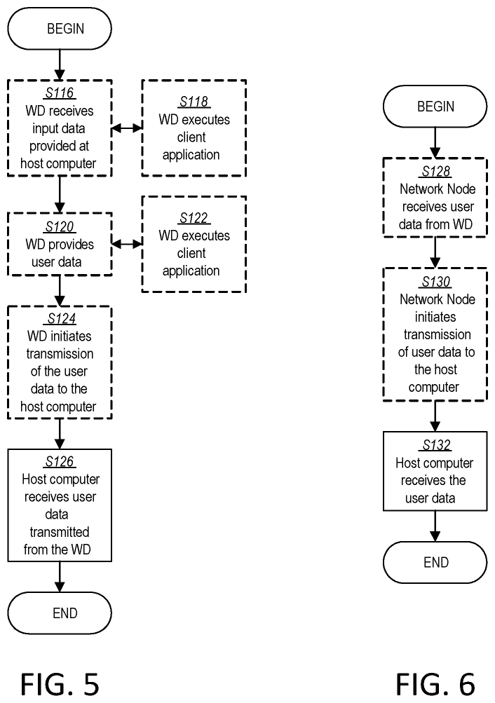

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 7 is a flowchart of an exemplary process in a network node 16 for using a mirror 23 according to the techniques described herein. One or more Blocks and/or functions and/or methods performed by the network node 16 may be performed by one or more elements of network node 16 such as by mirror configuration unit 32 in processing circuitry 68, processor 70 and/or radio interface 62, etc. according to the example method, which includes indicating (Block S134), such as via mirror configuration unit 32, processing circuitry 68, processor 70 and/or radio interface 62, at least one mirror 23 to a wireless device 22, WD, the at least one mirror 23 being used for positioning the wireless device 22. The method includes communicating (Block S136), such as via mirror configuration unit 32, processing circuitry 68, processor 70 and/or radio interface 62, at least one reference signal to the WD 22, the at least one reference signal to be reflected by the indicated at least one mirror 23 for positioning the wireless device 22. The method includes optionally, receiving (Block S138), such as via mirror configuration unit 32, processing circuitry 68, processor 70 and/or radio interface 62, a measurement report, the measurement report based at least in part on the reflected at least one reference signal.

In some embodiments, the indicated at least one mirror 23 represents at least one virtual transmission point, vTP. In some embodiments, indicating the at least one mirror 23 to the WD 22 further includes indicating, such as via mirror configuration unit 32, processing circuitry 68, processor 70 and/or radio interface 62, an existence of the at least one mirror 23 associated with the network node 16. In some embodiments, indicating the at least one mirror 23 to the WD 22 further includes indicating, such as via mirror configuration unit 32, processing circuitry 68, processor 70 and/or radio interface 62, at least one mirror configuration of the at least one mirror 23. In some embodiments, indicating the at least one mirror 23 to the WD 22 further includes indicating, such as via mirror configuration unit 32, processing circuitry 68, processor 70 and/or radio interface 62, a reference signal configuration associated with the at least one mirror 23. In some embodiments, indicating the at least one mirror 23 to the WD 22 further includes indicating, such as via mirror configuration unit 32, processing circuitry 68, processor 70 and/or radio interface 62, assistance data including the at least one mirror configuration of the at least one mirror 23.

In some embodiments, the at least one mirror configuration includes a reflection direction associated with the at least one mirror 23. In some embodiments, the at least one mirror configuration includes a transmission point location corresponding to the at least one mirror 23. In some embodiments, the at least one mirror configuration includes an indication of the at least one reference signal to be reflected by the at least one mirror 23. In some embodiments, the at least one mirror configuration includes an indication of a set of time resources associated with the at least one mirror configuration. In some embodiments, the at least one mirror configuration includes a cell identifier associating the at least one mirror configuration to a cell. In some embodiments, the at least one mirror configuration includes a number of the at least one mirror 23. In some embodiments, the at least one mirror configuration includes a location of each of the at least one mirror 23. In some embodiments, the at least one mirror configuration includes a request for a measurement associated with the at least one mirror configuration.

In some embodiments, the method further includes performing, such as via mirror configuration unit 32, processing circuitry 68, processor 70 and/or radio interface 62, at least one operational task based at least in part on the received measurement report. In some embodiments, the measurement report is a multipath report reporting on a number of paths, the number of paths based at least in part on a number of the at least one mirror 23. In some embodiments, the method further includes estimating, such as via mirror configuration unit 32, processing circuitry 68, processor 70 and/or radio interface 62, a position of the WD 22 based at least in part on the received measurement report.

In some embodiments, the method includes obtaining a mirror configuration (e.g., a first configuration, a second configuration, and/or an indication of an existence of use of a mirror 23 for positioning, etc.). The method includes communicating at least one reference signal to be reflected by at least one mirror 23 associated with the mirror configuration. The method includes receiving a measurement report, the measurement report based at least in part on the reflected at least one reference signal.

In some embodiments, the method further includes communicating an indication of the at least one reference signal to be reflected by the at least one mirror 23 associated with the mirror configuration. In some embodiments, the method further includes performing at least one operational task based at least in part on the measurement report. In some embodiments, the method further includes communicating at least one of an indication of the mirror configuration and an existence of the at least one mirror 23 associated with the mirror configuration to a wireless device (WD) 22.

FIG. 8 is a flowchart of an exemplary process in a wireless device 22 according to some embodiments of the present disclosure. One or more Blocks and/or functions and/or methods performed by WD 22 may be performed by one or more elements of WD 22 such as by measurement unit 34 in processing circuitry 84, processor 86 and/or radio interface 82, etc., which example method includes receiving (Block S140), such as via measurement unit 34, processing circuitry 84, processor 86 and/or radio interface 82, an indication of at least one mirror 23 from a network node 16, the at least one mirror 23 being used for positioning the wireless device 22. The method includes performing (Block S142), such as via measurement unit 34, processing circuitry 84, processor 86 and/or radio interface 82, a measurement on at least one reference signal reflected by the indicated at least one mirror 23. The method includes performing (Block S144), such as via measurement unit 34, processing circuitry 84, processor 86 and/or radio interface 82, at least one operational task associated with positioning the wireless device 22 based at least in part on the measurement.

In some embodiments, the at least one mirror represents at least one virtual transmission point, vTP. In some embodiments, receiving the indication of the at least one mirror 23 from the network node 16 further includes receiving, such as via measurement unit 34, processing circuitry 84, processor 86 and/or radio interface 82, an existence of the at least one mirror associated with the network node 16. In some embodiments, receiving the indication of the at least one mirror 23 from the network node 16 further includes receiving, such as via measurement unit 34, processing circuitry 84, processor 86 and/or radio interface 82, at least one mirror configuration of the at least one mirror 23. In some embodiments, receiving the indication of the at least one mirror 23 from the network node 16 further includes receiving, such as via measurement unit 34, processing circuitry 84, processor 86 and/or radio interface 82, a reference signal configuration associated with the at least one mirror 23. In some embodiments, receiving the indication of the at least one mirror 23 from the network node 16 further includes receiving, such as via measurement unit 34, processing circuitry 84, processor 86 and/or radio interface 82, assistance data including the at least one mirror configuration of the at least one mirror 23.

In some embodiments, the at least one mirror configuration includes a reflection direction associated with the at least one mirror 23. In some embodiments, the at least one mirror configuration includes a transmission point location corresponding to the at least one mirror 23. In some embodiments, the at least one mirror configuration includes an indication of the at least one reference signal to be reflected by the at least one mirror 23. In some embodiments, the at least one mirror configuration includes an indication of a set of time resources associated with the at least one mirror configuration. In some embodiments, the at least one mirror configuration includes a cell identifier associating the at least one mirror configuration to a cell. In some embodiments, the at least one mirror configuration includes a number of the at least one mirror 23. In some embodiments, the at least one mirror configuration includes a location of each of the at least one mirror 23. In some embodiments, the at least one mirror configuration includes a request for a measurement associated with the at least one mirror configuration.

In some embodiments, performing the at least one operational task based at least in part on the measurement further includes estimating, such as via measurement unit 34, processing circuitry 84, processor 86 and/or radio interface 82, a position of the WD 22 based at least in part on the measurement. In some embodiments, performing the at least one operational task based at least in part on the measurement further includes communicating, such as via measurement unit 34, processing circuitry 84, processor 86 and/or radio interface 82, a measurement report, the measurement report based at least in part on the measurement. In some embodiments, performing the at least one operational task based at least in part on the measurement further includes updating, such as via measurement unit 34, processing circuitry 84, processor 86 and/or radio interface 82, a radio measurement map based at least in part on the measurement. In some embodiments, the measurement report is a multipath report reporting on a number of paths, the number of paths based at least in part on a number of the at least one mirror 23 associated with the network node 16. In some embodiments, the method further includes receiving, such as via measurement unit 34, processing circuitry 84, processor 86 and/or radio interface 82, the at least one reference signal according to the indication of the at least one mirror 23.

In some embodiments, the method includes receiving an indication of an existence of at least one mirror 23 associated with a network node 16. In some embodiments, the method includes performing a measurement on at least one reference signal reflected by the at least one mirror 23. The method includes performing at least one operational task based at least in part on the measurement performed on the reflected at least one reference signal.

In some embodiments, the method further includes receiving the at least one reference signal reflected by the at least one mirror 23. In some embodiments, the method further includes communicating a measurement report, the measurement report based at least in part on the measurement performed on the at least one reference signal. In some embodiments, the measurement report is a multipath report with a number of paths in the multipath report based on a number of the at least one mirror 23 associated with the network node 16.

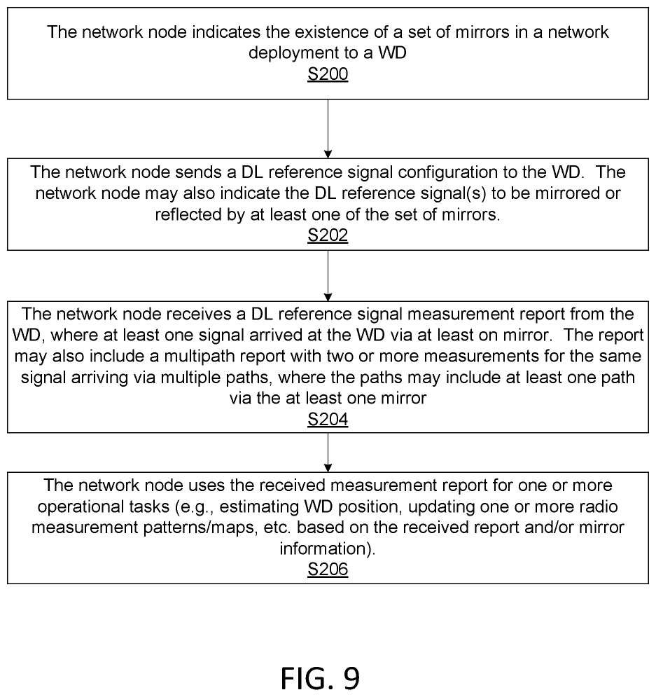

FIGS. 9-12, discussed below in detail, provide some additional examples of some embodiments of this disclosure, from the network node 16 and the WD 22 perspective. These example steps are provided for a downlink approach. Such embodiments can be similarly applied to an uplink approach, as well.

In FIG. 9, the example method from a network node 16 perspective is shown. The example method includes a network node 16 indicating the existence of a set of mirrors 23 in the network deployment to the WD 22 (Block S200). The network node 16 may then send a downlink (DL) reference signal to the WD 22 and indicate that the DL reference signals are to be mirrored by at least one of the set of mirrors 23 (Block S202). The network node 16 may receive the DL reference signal measurement report from the WD 22, where at least one signal arrived via at least one mirror 23 (Block S204). In some embodiments, the report may include a multipath report with two or measurements for the same signal arriving via multiple paths, the paths including at least one path via the at least one mirror 23. The network node 16 may use the received measurement report for one or more operational tasks, such as, for example, estimating the position of the WD 22, or updating one or more radio measurement patterns/maps, based on the received report and/or mirror information (Block S206). In some embodiments, Blocks S204 and S206 may not be applicable when the signal coming via the mirror 23 does not reach the WD 22 (e.g., the signal is too weak).

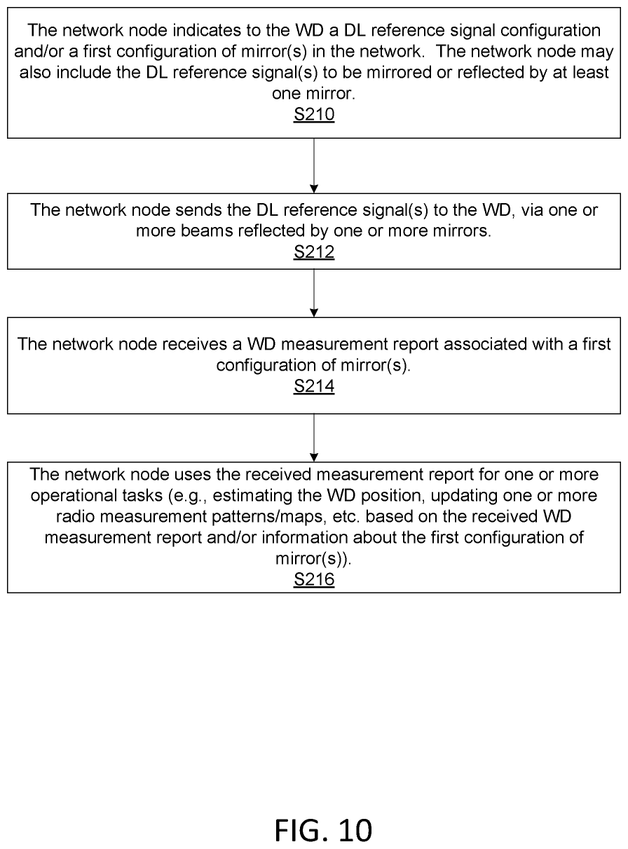

In FIG. 10, yet another example method is shown. The method includes the network node 16 indicating to the WD 22 the DL reference signal configuration and a first configuration of mirror(s) 23 in the network deployment (Block S210). The network node 16 may indicate e.g., to the WD 22 that the DL reference signals are to be mirrored by at least mirror 23. The network node 16 may send the DL reference signal(s) to the WD 22, via one or more beams reflected by one or more mirrors 23 (Block S212). The network node 16 may receive a WD 22 measurement report associated with the first configuration of mirror(s) 23 (Block S214). The network node 16 may use the received measurement report for one or more operational tasks, such as, for example, estimating the position of the WD 22, or updating one or more radio measurement patterns/maps, based on the received report and/or information about the first configuration of mirror(s) 23 (Block S216).

In some embodiments, there may also be additional optional steps (similar to the steps shown in FIG. 10) but for a second configuration of mirror(s) 23, where the network node 16 may use the WD 22 measurement reports (e.g., estimated WD 22 location or updates to the radio measurements patterns/maps) based on the second configuration differently from when the report is based on the first configuration of mirror(s) 23. A first and second mirror configuration of mirror(s) 23 may include different reflection directions, or a second configuration may comprise using mirrors 23 and the first configuration may comprise not using mirrors 23 or having the mirrors 23 configured to be OFF. For example, the location server may include different transmission point locations in the assistance data, depending on the mirror configuration, for WD 22 positioning calculations, or the location server may choose to update different radio measurement patterns/maps, or the location server may expect to receive from the WD 22 a measurement report including at least one different value for at least one reported parameter together with the WD 22 measurement, depending on the mirror configuration, etc.

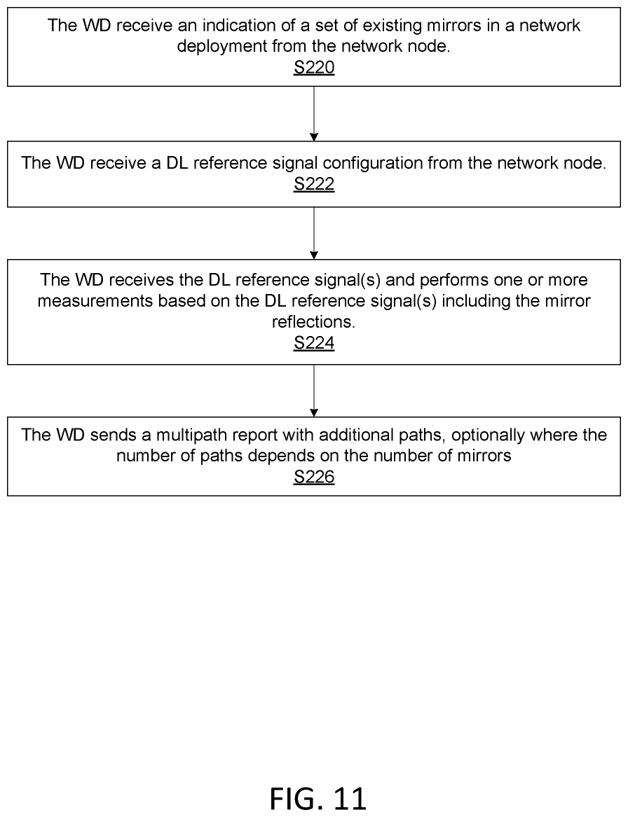

In FIG. 11, the example method from a WD 22 perspective is shown. The example method includes the WD 22 receiving the indication of a set of existing mirrors 23 in the network deployment from the network node 16 (Block S220). The method includes the WD 22 receiving the DL reference signal configuration from the network node 16 (Block S222). The method includes the WD 22 receiving the DL reference signal(s) and performing one or more measurements based on the DL reference signal(s) including the mirror reflections (Block S224). The method includes the WD 22 reporting multipath with additional paths, optionally, wherein the number of paths may depend on the number of mirrors 23 (Block S226).

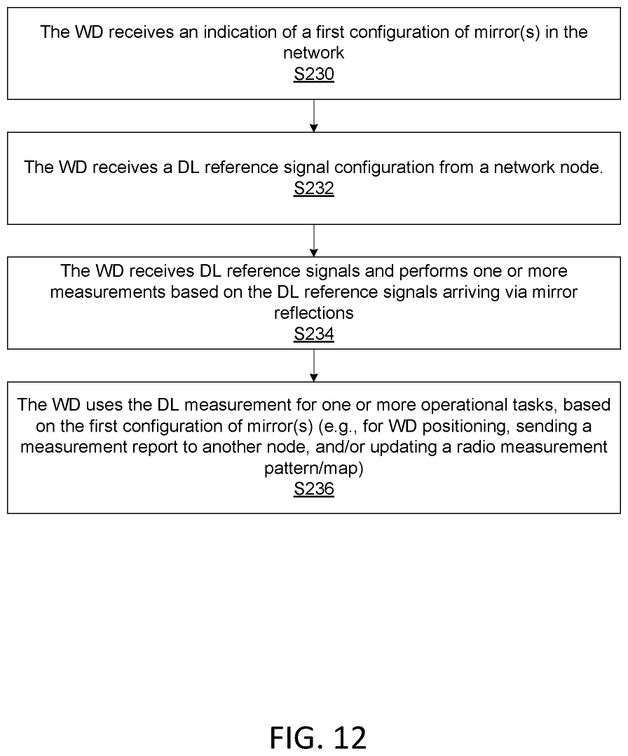

In FIG. 12, yet another example method from the WD 22 perspective is shown. The example method includes the WD 22 receiving the indication of a first configuration of mirror(s) 23 in the network (Block S230). The method includes the WD 22 receiving the DL reference signal configuration from the network node 16 (Block S232). The method includes the WD 22 receiving DL reference signal(s) and performing one or more measurements based on the DL reference signal(s) arriving via mirror reflections (Block S34). The method includes the WD 22 using the DL measurement(s) for one or operational tasks, such as, for example, the WD 22 positioning or sending a measurement report to another node or updating a radio measurement pattern/map (Block S236). In some embodiments, the using the DL measurement(s) may include position calculation, reporting, updating and/or maintaining radio measurements patterns/maps, etc.

In the example method of FIG. 12, there may also additional optional steps (similar to the steps shown in FIG. 12) but for a second configuration of mirror(s) 23, where the WD 22 uses the measurements based on the second configuration differently from when the measurements are based on the first configuration of mirror(s) 23. A first and second mirror configuration of mirror(s) 23 may include different reflection directions, or a second configuration may include using mirrors 23 and the first configuration may include not using mirrors 23 or having mirrors 23 set to OFF. For example, the WD 22 may use different transmission point (TP) locations, depending on the mirror configuration, for positioning calculation, or the WD 22 may choose to update a different radio measurements pattern/map, or the WD 22 measurement report may include at least one different value for at least one reported parameter together with the measurements, depending on the mirror configuration, etc.

Having generally described some embodiments for using mirrors 23 as a positioning solution, a more detailed description of some embodiments of this disclosure is described below.

In some environments, positioning with sufficient accuracy may require a high density of network nodes 16 (e.g., base stations (BSs)), e.g., in a factory environment. In such contexts, instead of installing a large number of network nodes 16, a reduced number of network nodes 16 (down to just one) plus a large number of mirrors 23 may be used. A network node 16 can have information about at least M mirrors 23 and can share such information with other nodes and/or WDs 22. In some embodiments, a particular mirror 23 may also be used by multiple mirrors 23. It should be noted that the M number of mirrors 23 may be associated with one particular network node 16, yet the M mirrors 23 may not be likely to be the total number of mirrors 23 in the entire network.

In some embodiments, a mirror 23 is a node or equipment with a certain reflecting capability. It may, for example, be flat, curved, fully reflective or semi-transparent, reflecting in several distinct directions. In some examples, the reflection direction(s) (or more generally, the mirror configuration, which may include height, direction, etc.) may be adjusted or controlled via a direct physical interaction or remotely, statically, semi-statically, or dynamically. In one example, a first mirror configuration may be associated with a first set of time resources, and a second mirror configuration may be associated with a second set of time resources. In another example, a mirror's reflecting capability can be controlled to be ON or OFF.

In some embodiments, a mirror 23 may be installed to receive line-of-sight (LOS) signals from at least one network node 16 and the mirror 23 may be directed/oriented to reflect a LOS signal in a different direction, e.g., to enable the signal from the network node 16 in an area where otherwise its signal reachability would be difficult (e.g., low quality and/or arriving via multipath). Using mirrors 23 can thus make it possible to “deliver” or redirect the signals in a desired/target direction, or in a tunnel. In some embodiments, the effect of a standing wave generated by the reflecting surface should be avoided. A standing wave may result when the original and reflected signal waves become opposite and thus the combined signal becomes very weak; hence the directions of mirrors 23 may be carefully planned or controlled or configured (e.g., by network node 16) to avoid this effect. In some embodiments, for example, a delay for different signals may be configured deliberately, e.g., in a case where orthogonal frequency division multiplexing (OFDM) using a cyclic time shift of the OFDM symbol may be implemented (e.g., by network node 16) in order to avoid such undesired effects. Information about such applied time shifts may be used in the positioning algorithm, where such shifts can be compensated for. Such information may also be transmitted (e.g., by network node 16) to the WD 22 in some embodiments.

In some embodiments, e.g., for methods including the use of unique signals over multiple locations such as OTDOA, an isolation technique, using, e.g., orthogonality and/or different code sequences, may be used to avoid the same signal sequence coming from two or more directions, unless, for example, the WDs 22 are capable of differentiating between the multiple signal instances e.g., based on their time of arrival (TOA).

In some embodiments, the network node 16 can indicate, in the DL assistance data, that a certain DL reference signal is subject to mirrors 23. In some examples, this may be performed explicitly, or implicitly via e.g., implying that the WD 22 should report multiple paths, or a higher number of additional paths than usual, due to the mirrors 23. In some embodiments, the WD 22 may be configured to report paths only up to the strongest (without mirrors 23 or with mirrors 23 set to off), while for mirror-reflected reference signals, the WD 22 should report paths also beyond the strongest, etc. In some embodiments, e.g., when narrow beamforming is used, each mirror 23 may potentially be associated with orthogonal positioning sequences and/or sequences encoded with different code sequences. This may also be applied to the LOS path, which may be different from the reflected paths in the same or similar manner.

In some embodiments, the mirror configuration could also be interpreted by the WD 22 as an indication to use a wider search window in time for the DL reference signal(s).

In some embodiments, the total number of reported additional paths may depend on the number of associated mirrors, or may be the same as the number of detected additional paths, optionally limited by a max number. In some embodiments, the total number of reported paths may be further restricted by a preconfigured or configured threshold. Such threshold may imply that paths detected at a strength within the threshold from the strongest detected path should be included in the measurement report.

In other embodiments, where each mirror 23 reflects a dedicated signal (e.g., using orthogonality and/or coding), the different paths corresponding to the different signals may be easier to resolve, as compared to non-dedicated signals.

In some embodiments, the network node 16 may use a combination of discrimination of different positioning signals via e.g., orthogonality and/or codes, and/or additional path reporting (for each positioning signal) together with the information (e.g., distance/direction) known about the mirrors 23 and the TPs to estimate the WD's 22 position.

In some embodiments, for positioning which is not based on timing measurements, even the measurements patterns based on combined signals, e.g., reference signal received power (RSRP)-like measurements and signal quality measurements (e.g., reference signal received quality (RSRQ) or signal-to-interference-plus-noise ratio (SINR)), In some embodiments, “combined” means that the original signal is combined with one or more reflected signal(s). In such cases, the fingerprints of the combined signals may be used to locate the WD 22. However, in this case, to have accurate pattern matching (or fingerprinting or adaptive enhance cell ID (AECID)) for positioning of a WD 22, separate radio measurement patterns/maps may be created, maintained and/or used (e.g., by network node 16 and/or WD 22) for different mirror configurations (e.g., different mirror 23 heights and/or directions and/or even mirror 23 on/off states if the mirrors' reflecting ability can be controlled). For example, given a certain mirror configuration, a location server uses the corresponding radio measurement pattern/map to determine the WD 22 location. Alternatively, depending on the current mirror configuration, a network node 16 may provide or indicates the corresponding pattern/map to the WD 22 to be used by the WD 22 for determining the WD 22 location. Also, depending on the current mirror configuration, the network node 16 may collect and update the corresponding patterns/maps.

Mirrors and Beamforming

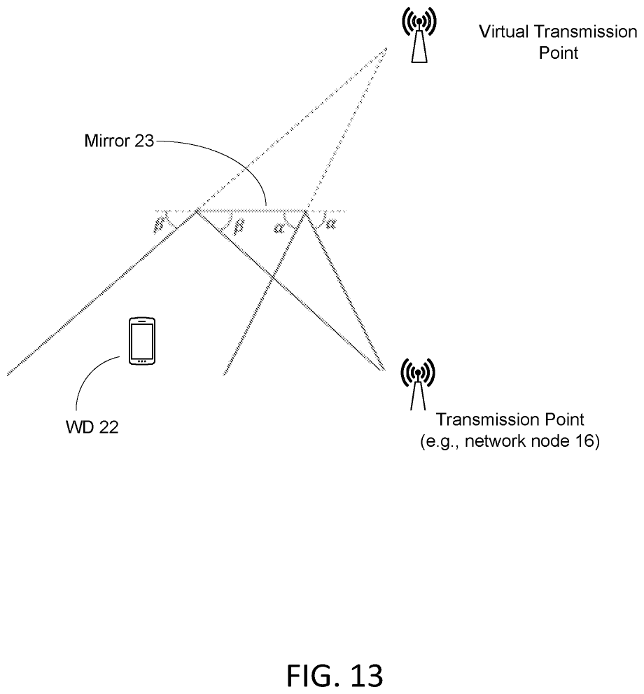

In some embodiments, the network node 16 may use narrow beams, directed to these mirrors 23. The mirrors 23 may be installed and oriented in such a way that the reflected wave from each mirror 23 is redirected toward a desired/target direction. In this way, each mirror 23 may serve as a virtual Transmission Point (vTP), with a known or predetermined virtual position (the virtual position may not be the same as the mirror position as shown in FIG. 13 for example).

In some embodiments, the mirrors 23 can optionally be made convex to make the resulting beam wider, or concave to make the resulting beam narrower.

In some embodiments, the mirrors 23 may optionally be connected in a serial manner to reach difficult positions, i.e., a network node 16 signal may reach a first mirror 23, which reflects the wave toward a second mirror 23, etc. (network node->Mirror 1->Mirror 2-> . . . etc.). In some embodiments, the mirrors 23 could thus be considered as first level mirrors 23 (M1), secondary mirrors 23 (M2), etc.

In principle, each network node 16 may reach an unlimited number of level one” M1 mirrors. After each M1 mirror there may be zero, one or more additional levels.

In some embodiments, a particular mirror 23 may also be used by several network nodes 16. Such mirror 23 may thereby serve as several vTPs.

In some embodiments, with N network nodes 16 and M mirrors 23 there may then be N*M vTPs, such as, for example: 10 network nodes and 100 Mirrors->(potentially) 1000 vTPs.

In some embodiments, it may be considered that N network nodes and M Mirrors provide M virtual TPs with N beams each. In some embodiments, it may be considered that with few network node's 16 the virtual TPs may have few beams and will thus may be considered less useful than the network node's 16, but as the number of network nodes 16 grows the virtual TPs may receive more beams and thus become even more useful.

In some embodiments, the beam directions may be automatically determined (e.g., by network node 16 and/or WD 22) by a combination of beam sweeping and a detection mechanism at each mirror 23 reporting back to the network in such a way that the detection is associated with a particular beam direction.

In some embodiments (e.g., assuming flat mirrors) the beam widths of the reflected signals at a WD 22 will correspond to the distance to the virtual Transmission Point and not the distance of the WD 22 to a particular mirror, since the network node 16 beam may have already expanded while reaching the mirrors.

In some embodiments, the transmission beams from a particular network node 16 towards several mirrors 23 may be super-positioned in the same OFDM symbol using orthogonal subsets of Resource Elements (REs) and/or scrambling with different code sequences. Alternatively, the transmission beams could use different OFDM symbols, or a combination of time and frequency resources.

In some embodiments, different network nodes 16 may transmit using a combination of orthogonal signals and differently coded sequences. In some embodiments, using higher frequencies may facilitate narrow beamforming and allow the size of a mirror 23 to be reduced, compared to lower frequencies.

In some embodiments, when the same system is used for both communication and positioning the system may be configured to use the positioning-oriented beamforming only on time/frequency resource elements (REs) where DL reference signals are transmitted, and other antenna diagrams on REs used for data communication. Alternatively, the mirrors 23 may also be used for communication to e.g., increase spatial diversity.

In some embodiments, parts of a roof and/or walls may be used as “mirrors” (or reflective surfaces), which combined with a virtual map of the environment could be utilized as a continuum of TPs. In some further embodiments, the surfaces of the roof/walls may be coated to improve the reflective properties.

Uplink and Downlink Methods

In some embodiments, the techniques described herein can be applied to both uplink and/or downlink methods. While the embodiments described herein above may be described for a downlink procedure, it should be apparent that the description may also be applied for the uplink, e.g. if the WD 22 sends a reference signal in the uplink, the network node 16 would be receiving the signal via one or more mirrors. The same or different mirrors 23 could be used for DL and UL, which may be controlled e.g., by scheduling and/or a configuration of transmission directions. At the network node 16, it may be possible to compute the time of arrival of the reference signals from the WD 22 and the respective reflections of the signal(s) from other corresponding mirrors. Aside from timing information, the angle of arrival (AoA), angle of departure (AoD), and other similar reflection information determined at the network node 16 can be used together with the placement of the mirrors/reflectors/virtual transmission points to estimate the WD's 22 position.

Mirror Configuration and Reporting Based on the Mirror

In some embodiments, Long Term Evolution (LTE) Positioning Protocol (LLP) messages are configured to include the mirror support for the techniques described in this disclosure. For example, an LLP message may indicate a WD 22 capability to report the measurements based on the configured mirrors.

At least one or more of the following LPP message types may be updated accordingly for mirror 23 support:
Request Capabilities;
Provide Capabilities;
Request Assistance Data;
Provide Assistance Data;
Request Location Information;
Provide Location Information;
Abort; and
Error.

In some embodiments, the provide assistance data message may include the configuration related to mirrors, as follows, for example:

| Mirror-ProvideAssiatanceData ::= SEQUENCE { | |
|---|---|
| numberOfMirrors | INTEGER {0..maxNumber} |
| mirror-Coordinates | Mirror-Coordinates |

| physCellId | INTEGER (0..1007), | | |
|---|---|---|---|
| cellGlobalId | ECGI | OPTIONAL | -- Need |

ON
}.

In some embodiments, the mirrors 23 are associated to a reference signal configuration and/or a beam instead of cell. The reference signal and/or mean can be associated to an identifier, which in turn can be used to make associations to a mirror. One example of an identifier is a physical cell ID as above, but can also be abeam ID, reference signal (RS) ID, positioning reference signal ID, etc.

In some embodiments, the location coordinates can be in earth-centered, earth-fixed (ECEF) co-ordinates or based upon a relative distance co-ordinate to a reference point. In further embodiments, a confidence and/or uncertainty factor can also be provided for each co-ordinate, as follows, for example:

Mirror-Coordinates ::= SEQUENCE {

| | |
|---|---|
| mirror-reference-point-ECEF-X-r15 | INTEGER (− |

137438953472..137438953471),

| | |
|---|---|
| mirror-reference-point-ECEF-Y-r15 | INTEGER (− |

137438953472..137438953471),

| | |
|---|---|
| mirror-reference-point-ECEF-Z-r15 | INTEGER (−137438953472..137438953471), |

}

| | |
|---|---|
| uncertainty-X-r15 | INTEGER (0..255), |
| confidence-X-r15 | INTEGER (0..100) |
| uncertainty-Y-r15 | INTEGER (0..255) |
| confidence-Y-r15 | INTEGER (0..100) |
| uncertainty-Z-r15 | INTEGER (0..255) |
| confidence-Z-r15 | INTEGER (0..100). |

In some embodiments, a mirror 23 may instead be represented by a line, a polygon, a plane, or a set of planes. In some embodiments, a line can be described or represented by a point and a direction, optionally with limitations in extensions along the direction. In some embodiments, a polygon can be described or represented by a point and a pair of directions, optionally with limitations in extensions along one or both of these directions.

In some embodiments, the one or more mirrors 23 can be pre-configured, or configured via LPP or some other similar protocol with a network node 16, such as the location server, or the mirrors 23 can be configured via an application layer, for example as part of a digital map. The information can be provided on demand or unsolicited.

Further, the LPP Annex (LLPa or New Radio Positioning Protocol (NRPPa)) message can be updated such that network nodes 16 (e.g., gNBs) can report the number and locations of mirrors 23 and in which cell ID or Beam ID the mirrors 23 are present.

Further, LPP messages can be extended to request certain measurements such as WD 22 RxTx/RSRP/RSRQ/TOA/TDOA measurements, based upon the configured mirrors 23 as follows, for example:

-- ASN1START
Mirror-RequestLocationInformation ::= SEQUENCE {

| | | |
|---|---|---|
| requestedMeasurements | BIT STRING { rsrpReq | (0), |

| rsrqReq (1), | |
|---|---|
| ueRxTxReq | (2), |
| nrsrpReq-r14 | (3), |
| nrsrqReq-r14 | (4)} (SIZE(1..8)), |

...

}
-- ASN1STOP.

In some embodiments, the mirror-based positioning techniques described in this disclosure may be used as a hybrid positioning method such that e.g., the E-CID-based report can be sent along with a mirror-based report e.g., so that the location server can process the results to obtain a more accurate estimate of the WD 22 location, as compared to positioning estimates that do not use mirrors.

Furthermore, the presence of mirrors 23 may impact the number of paths the WD 22 is configured to report. In one example embodiment, this impacts the number of additional paths reported for OTDOA, exemplified with LPP reporting for OTDOA as follows, for example:

OTDOA-SignalMeasurementInformation ::= SEQUENCE {

| | |
|---|---|
| systemFrameNumber | BIT STRING (SIZE (10)), |

| | |
|---|---|
| physCellIdRef | INTEGER (0..503), |

| | | |
|---|---|---|
| cellGlobalIdRef | ECGI | OPTIONAL, |

| | | | |
|---|---|---|---|
| earfcnRef | ARFCN-ValueEUTRA | OPTIONAL, | -- Cond |

NotSameAsRef0

| | | |
|---|---|---|
| referenceQuality | OTDOA-MeasQuality | OPTIONAL, |

| neighbourMeasurementList NeighbourMeasurementList, | | | |
|---|---|---|---|
| ..., | | | |
| [[ earfcnRef-v9a0 | ARFCN-ValueEUTRA-v9a0 | OPTIONAL | -- |

Cond NotSameAsRef1

| ]], | | | |
|---|---|---|---|
| [[ tpIdRef-r14 | INTEGER (0..4095) | OPTIONAL, | -- Cond |

ProvidedByServer0

| | | | |
|---|---|---|---|
| prsIdRef-r14 | INTEGER (0..4095) | OPTIONAL, | -- Cond |

ProvidedByServer1

| additionalPathsRef-r14 | | | |
|---|---|---|---|
| | AdditionalPathList-r14 OPTIONAL, | | |
| nprsIdRef-r14 | INTEGER (0..4095) | OPTIONAL, | -- Cond |

ProvidedByServer2

carrierFreqOffsetNB-Ref-r14

| | | |
|---|---|---|
| CarrierFreqOffsetNB-r14 | OPTIONAL, | -- Cond |

NB-IoT

| | | | |
|---|---|---|---|
| hyperSFN-r14 | BIT STRING (SIZE (10)) | OPTIONAL | -- Cond |

H-SFN

]],
[[

| | |
|---|---|
| motionTimeSource-r15 MotionTimeSource-r15 | OPTIONAL |

]]

}
NeighbourMeasurementList ::= SEQUENCE (SIZE(1..24)) OF
NeighbourMeasurementElement
NeighbourMeasurementElement ::= SEQUENCE {

| physCellIdNeighbour | INTEGER (0..503), | | |
|---|---|---|---|
| cellGlobalIdNeighbour ECGI OPTIONAL, | | | |
| earfcnNeighbour | ARFCN-ValueEUTRA | OPTIONAL, | -- |

Cond NotSameAsRef2

| rstd INTEGER (0..12711), | |
|---|---|
| rstd-Quality | OTDOA-MeasQuality, |

| ..., | | | |
|---|---|---|---|
| [[ earfcnNeighbour-v9a0 | ARFCN-ValueEUTRA-v9a0 | OPTIONAL | -- |

Cond NotSameAsRef3

| ]], | | | |
|---|---|---|---|
| [[ tpIdNeighbour-r14 | INTEGER (0..4095) | OPTIONAL, | -- Cond |

ProvidedByServer0

| | | | |
|---|---|---|---|
| prsIdNeighbour-r14 | INTEGER (0..4095) | OPTIONAL, | -- Cond |

ProvidedByServer1

| | | |
|---|---|---|
| delta-rstd-r14 | INTEGER (0..5) | OPTIONAL, |

additionalPathsNeighbour-r14

AdditionalPathList-r14 OPTIONAL,

| | | | |
|---|---|---|---|
| nprsIdNeighbour-r14 | INTEGER (0..4095) | OPTIONAL, | -- |

Cond ProvidedByServer2

carrierFreqOffsetNB-Neighbour-r14

| | | |
|---|---|---|
| CarrierFreqOffsetNB-r14 | OPTIONAL | -- Cond |

NB-IoT

]],
[[

| | | |
|---|---|---|
| delta-SFN-r15 | INTEGER (−8192..8191) | OPTIONAL |

]]

}
AdditionalPathList-r16 ::= SEQUENCE (SIZE(1..maxPaths-r16)) OF
AdditionalPath-r16
}

The variable maxPaths above is bolded and may be different for cells where mirrors 23 are expected to be present. For example, maxPaths may be one value when mirrors 23 are expected to be present and a different value when mirrors 23 are not present (or are configured as off). The information about whether mirrors 23 are expected to be used can also be considered an “indication,” as used herein.

In one mode, the maxPath is configured per cell. In another mode, the WD 22 can determine a suitable number of paths depending on the number of reliably detected paths.

Accordingly, at least some embodiments in this disclosure may dynamically increase the diversity of received reference signals, e.g., positioning reference signals (PRSs) on cells that may result in measurements, for example reference signal time difference (RSTD) measurements, that can contribute significantly to improved position accuracy as compared with known positioning solutions. Some embodiments may minimize downlink (and/or uplink) waste-to-accuracy ratio.

Some embodiments may include one or more of the following:

Embodiment A1. A network node configured to communicate with a wireless device (WD), the network node configured to, and/or comprising a radio interface and/or comprising processing circuitry configured to:

determine a mirror configuration;

communicate at least one reference signal to be reflected by at least one mirror associated with the mirror configuration; and

receive a measurement report, the measurement report based at least in part on the reflected at least one reference signal

Embodiment A2. The network node of Embodiment A1, wherein the processing circuitry is further configured to communicate an indication of the at least one reference signal to be reflected by the at least one mirror associated with the mirror configuration.

Embodiment A3. The network node of Embodiment A1, wherein the processing circuitry is further configured to perform at least one operational task based at least in part on the measurement report.

Embodiment A4. The network node of Embodiment A1, wherein the processing circuitry is further configured to communicate at least one of an indication of the mirror configuration and an existence of the at least one mirror associated with the mirror configuration to the WD.

Embodiment B1. A method implemented in a network node, the method comprising:

obtaining a mirror configuration;

communicating at least one reference signal to be reflected by at least one mirror associated with the mirror configuration; and

receiving a measurement report, the measurement report based at least in part on the reflected at least one reference signal.

Embodiment B2. The method of Embodiment B1, further comprising communicating an indication of the at least one reference signal to be reflected by the at least one mirror associated with the mirror configuration.

Embodiment B3. The method of Embodiment B1, further comprising performing at least one operational task based at least in part on the measurement report.

Embodiment B4. The method of Embodiment B1, further comprising communicating at least one of an indication of the mirror configuration and an existence of the at least one mirror associated with the mirror configuration to a wireless device (WD).

Embodiment C1. A wireless device (WD) configured to communicate with a network node, the WD configured to, and/or comprising a radio interface and/or processing circuitry configured to:

receive an indication of an existence of at least one mirror associated with a network node;

perform a measurement on at least one reference signal reflected by the at least one mirror; and

perform at least one operational task based at least in part on the measurement performed on the reflected at least one reference signal.

Embodiment C2. The WD of Embodiment C1, wherein the processing circuitry is further configured to receive the at least one reference signal reflected by the at least one mirror.

Embodiment C3. The WD of Embodiment C1, wherein the processing circuitry is further configured to communicate a measurement report, the measurement report based at least in part on the measurement performed on the at least one reference signal.

Embodiment C4. The WD of Embodiment C3, wherein the measurement report is a multipath report with a number of paths in the multipath report based on a number of the at least one mirror associated with the network node.

Embodiment D1. A method implemented in a wireless device (WD), the method comprising:

receiving an indication of an existence of at least one mirror associated with a network node;

performing a measurement on at least one reference signal reflected by the at least one mirror; and

performing at least one operational task based at least in part on the measurement performed on the reflected at least one reference signal.

Embodiment D2. The method of Embodiment D1, further comprising receiving the at least one reference signal reflected by the at least one mirror.

Embodiment D3. The method of Embodiment D1, further comprising communicating a measurement report, the measurement report based at least in part on the measurement performed on the at least one reference signal.

Embodiment D4. The method of Embodiment D3, wherein the measurement report is a multipath report with a number of paths in the multipath report based on a number of the at least one mirror associated with the network node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a wireless device, WD, the method comprising:
receiving an indication of at least one mirror from a network node, the at least one mirror being used for positioning the wireless device;
performing a measurement on at least one reference signal reflected by the indicated at least one mirror; and
performing at least one operational task associated with positioning the wireless device based at least in part on the measurement.

2. The method of claim 1, wherein the at least one mirror represents at least one virtual transmission point, vTP.

3. The method of claim 1, wherein
receiving the indication of the at least one mirror from the network node further comprises receiving at least one of:
an existence of the at least one mirror associated with the network node;
at least one mirror configuration of the at least one mirror;
a reference signal configuration associated with the at least one mirror; and
assistance data including the at least one mirror configuration of the at least one mirror.

4. (canceled)

5. The method of claim 1, wherein performing the at least one operational task based at least in part on the measurement further comprises at least one of:
estimating a position of the WD based at least in part on the measurement;
communicating a measurement report, the measurement report based at least in part on the measurement; and
updating a radio measurement map based at least in part on the measurement.

6. (canceled)

7. The method of claim 1, further comprising:
receiving the at least one reference signal according to the indication of the at least one mirror.

8. A wireless device, WD, configured to communicate with a network node, the WD comprising processing circuitry, the processing circuitry configured to cause the WD to:
receive an indication of at least one mirror from a network node, the at least one mirror being used for positioning the wireless device;
perform a measurement on at least one reference signal reflected by the indicated at least one mirror; and
perform at least one operational task associated with positioning the wireless device based at least in part on the measurement.

9. The wireless device of claim 8, wherein the at least one mirror represents at least one virtual transmission point, vTP.

10. The wireless device of claim 8, wherein the processing circuitry is further configured to cause the wireless device to receive the indication of the at least one mirror from the network node by being configured to cause the wireless device to receive at least one of:
an existence of the at least one mirror associated with the network node;
at least one mirror configuration of the at least one mirror;
a reference signal configuration associated with the at least one mirror; and
assistance data including the at least one mirror configuration of the at least one mirror.

11. (canceled)

12. The wireless device of claim 8, wherein the processing circuitry is further configured to cause the wireless device to perform the at least one operational task based at least in part on the measurement by being configured to cause the wireless device to at least one of:
estimate a position of the WD based at least in part on the measurement;
communicate a measurement report, the measurement report based at least in part on the measurement; and
update a radio measurement map based at least in part on the measurement.

13. (canceled)

14. The wireless device of claim 8, wherein the processing circuitry is further configured to cause the wireless device to:
receive the at least one reference signal according to the indication of the at least one mirror.

15. A method implemented in a network node, the method comprising:
indicating at least one mirror to a wireless device, WD, the at least one mirror being used for positioning the wireless device;
communicating at least one reference signal to the WD, the at least one reference signal to be reflected by the indicated at least one mirror for positioning the wireless device; and
receiving a measurement report, the measurement report based at least in part on the reflected at least one reference signal.

16. The method of claim 15, wherein the indicated at least one mirror represents at least one virtual transmission point, vTP.

17. The method of claim 15, wherein indicating the at least one mirror to the WD further comprises indicating at least one of:
an existence of the at least one mirror associated with the network node;
at least one mirror configuration of the at least one mirror;
a reference signal configuration associated with the at least one mirror; and
assistance data including the at least one mirror configuration of the at least one mirror.

18. (canceled)

19. (canceled)

20. The method of claim 15, wherein the measurement report is a multipath report reporting on a number of paths, the number of paths based at least in part on a number of the at least one mirror.

21. The method of claim 15, further comprising:
estimating a position of the WD based at least in part on the received measurement report.

22. A network node configured to communicate with a wireless device, WD, the network node comprising processing circuitry, the processing circuitry configured to cause the network node to:
indicate at least one mirror to a wireless device, WD, the at least one mirror being used for positioning the wireless device;
communicate at least one reference signal to the WD, the at least one reference signal to be reflected by the indicated at least one mirror for positioning the wireless device; and
receive a measurement report, the measurement report based at least in part on the reflected at least one reference signal.

23. The network node of claim 22, wherein the indicated at least one mirror represents at least one virtual transmission point, vTP.

24. The network node of claim 22, wherein the processing circuitry is further configured to cause the network node to indicate the at least one mirror to the WD by being further configured to cause the network node to indicate at least one of:
an existence of the at least one mirror associated with the network node;
at least one mirror configuration of the at least one mirror;
a reference signal configuration associated with the at least one mirror; and
assistance data including the at least one mirror configuration of the at least one mirror.

25. (canceled)

26. (canceled)

27. The network node of claim 22, wherein the measurement report is a multipath report reporting on a number of paths, the number of paths based at least in part on a number of the at least one mirror.

28. The network node of claim 22, wherein the processing circuitry is further configured to cause the network node to:
estimate a position of the WD based at least in part on the received measurement report.
